(19) United States
(12) Patent Application Publication
(10) Pub. No.: US 2026/0286954 A1
(43) Pub. Date: Sep. 24, 2026

(54) PISTON OF A MEMBRANE FILTRATION SYSTEM

(71) Applicant: Salinity Solutions Ltd, Birmingham (GB)

(72) Inventors: Timothy Naughton, Birmingham (GB); Liam Burlace, Birmingham (GB); Philip Davies

(73) Assignee: Salinity Solutions Ltd, Birmingham, OT (GB)

(21) Appl. No.: 19/474,975

(22) PCT Filed: Apr. 14, 2024
(86) PCT No.: PCT/GB2024/050973

§ 371 Date: Oct. 13, 2025

(30) Foreign Application Priority Data
Apr. 14, 2023 (GB) 2305564.3

(51) Int. Cl. F04B 53/14; C02F 1/44

(52) U.S. Cl. CPC F04B 53/143; C02F 1/441; C02F 2201/004

(57) ABSTRACT

A piston assembly for use in a fluid circulation system comprises a piston housing separated by a piston in a first chamber and a second chamber. The piston fluidly separates the first chamber from the second chamber, and is moveable to change the volumes of the first and second chambers. At least one chamber comprises two fluid ports, spaced apart from each other. The piston comprises a passage, that connects the two fluid ports when the piston is moved to one side of the first chamber, while sealing the first chamber from the second chamber. Further disclosed is a piston for use with a piston assembly. The piston permits pressurisation of each chamber while providing a bypass passage through the two fluid ports.

### FIELD OF THE INVENTION

The present invention relates to a fluid separation system and method of operating a fluid separation system. More specifically, the present invention relates to a component design and method of operating a fluid separation system to improve its performance. In examples, the invention relates to a membrane desalination system.

### BACKGROUND

Recent developments in water desalination and other membrane-based separation processes for the decontamination and/or purification of fluids have resulted in more energy efficient system designs, such as described in International Patent Publications WO2020/039158A1 and WO2022/096895A2. Improved understanding of operating control processes and selection of components have led to the development of fluid separation systems that may operate practically uninterrupted for prolonged periods of time, in the region of several months in line with cleaning cycles for the equipment used, e.g., for desalination membranes.

Such separation systems separate, by design, fluid into a “clean” (e.g., desalinated) permeate and a retentate with an increased concentration of the contaminant or component to be removed. A limit to the operation of such separation systems is posed by scaling or fouling processes due to the chemical interaction of high-intentionally enriched-concentrations of the component/contaminant to be removed with system components. For this reason, equipment maintenance is still required in regular intervals, even if regular intervals may be several months apart.

The present disclosure seeks to provide solutions for the amelioration of problems associated with long-term exposure to a concentration of retained components, in an endeavour to increase service intervals of separation systems and/or increase longevity of system components.

### SUMMARY OF THE INVENTION

In accordance with a first aspect of the invention, there is disclosed a piston assembly as defined in claim 1, for use in a fluid circulation system, the piston assembly comprising a piston housing defining a chamber comprising a first chamber end and a second chamber end, the piston assembly comprising a piston body comprising a sealing portion to fluidly separate the first chamber end from the second chamber end, the piston body moveably disposed to allow it to change the volumes of the first and second chamber ends, respectively, wherein at least the first chamber end comprises a first fluid port and a second fluid port spaced apart from the first fluid port, wherein the piston body comprises a first piston passage open to a first side of the sealing portion, the first piston passage providing a first connecting passage from the first fluid port to the second fluid port when the piston body is located at the first chamber end, and wherein the sealing portion maintains fluid separation to the second chamber end.

The piston assembly may be for use as, or as part of, a pressurising, or charging, module in a fluid separation system, specifically a charging module described herein as part of a further aspect, wherein the charging module comprises chambers supplied by fluid ports located at different locations of the charging module. An appreciation underlying the invention was that operation of a piston assembly of such a charging module may be limited by the location of fluid ports when fluid flow between two ports needs to be maintained. The provision of a first piston passage within a piston, open to one side of the sealing portion, e.g., open either to a “left” or “right” side, allows the piston passage to provide a bypass conduit through the piston body. In this manner, the system operation may allow modes and phases during which the piston may pass fluid ports, without blocking them, as would otherwise be the case in the absence of a bypass conduit.

In some embodiments, one of the first fluid port and the second fluid port is located at an end face of the first chamber.

One or more fluid ports to be connected by a bypass conduit may be at an end cap or other end connection of the first chamber. For instance, the bypass may provide a return conduit from an axial centre to a peri-axial port.

In some embodiments, the other of the first fluid port and the second fluid port is located laterally of the end face of the first chamber.

One or more fluid ports to be connected by a bypass conduit may be on a mantle surface or lateral surface of the housing (e.g., charging chamber) along which the piston body is configured to move. For instance, the bypass may provide an elbow conduit from a port located axially to another port located at the mantle of the housing.

In some embodiments, the second chamber end comprises a third fluid port and a fourth fluid port spaced from the third fluid port, wherein the piston body comprises a second piston passage open to a second side of the sealing portion, the second piston passage providing a second connecting passage from the third fluid port to the fourth fluid port when the piston body is located at the second chamber end, and wherein the sealing portion maintains fluid separation to the first chamber end.

The position body may, in this manner, comprise two bypass conduits, e.g. on opposite sides. For instance, one bypass conduit may be provided on a “left” side and one on a “right side”, wherein the bypass conduits for ports of the “left” side remain fluidly isolated from ports of the “right” side.

In some embodiments, one of the third fluid port and the fourth fluid port is located at an end face of the second chamber.

In some embodiments, the other of the third fluid port and the fourth fluid port is located laterally of the end face of the second chamber.

In accordance with a second aspect of the invention, there is disclosed a piston body as defined in claim 7, the piston body being for use with a separation system described herein as further aspect, or for use with a piston assembly in accordance with the first aspect, the piston comprising a body comprising an elongate extension between two opposite ends, the body comprising a body portion partway between the two opposite ends arranged to fluidly isolate the two opposite ends, wherein the opposite ends each comprise an end face and a mantle portion defined by a perimeter of the body, and wherein the body comprises a piston passage extending from an end face to the mantle portion.

In some embodiments, the piston assembly or a piston body comprises at least one piston passage at each one of its opposite ends.

In some embodiments, a piston passage comprises a plurality of mantle openings on the piston body.

The mantle openings are understood to be openings extending outward, e.g., radially, to provide a port on a mantle surface of the piston.

In some embodiments, the mantle openings are radially spaced apart on the piston body.

For instance, two or more mantle openings may be equiangularly spaced apart around the mantle.

In some embodiments, the piston body comprises a groove into which one of the ports of the piston passage extends.

In some embodiments, the groove is provided peripherally on a mantle surface of the piston body.

The groove may facilitate flow into and out of the mantle opening.

In some embodiments, at least one of the ports is located centrally on an end face of the piston body.

In some embodiments, at least one of the ports is located off-centre on an end face of the piston body.

In some embodiments, the sealing portion comprises a surface of the piston body.

In some embodiments, the sealing portion comprises one or more seal elements.

The one or more seal elements are understood to be provided to maintain fluid isolation between the first chamber and the second chamber. The one or more seal elements may be provided by a dynamic seal element such as O-rings or profiled seals and the like.

In some embodiments, the piston body comprises a sensor-locatable element for use with a position sensor.

The sensor-locatable element may be a magnetic band or other suitable contrast-providing structure to allow a suitable sensor to detect the position of the piston body along the piston housing. An arrangement comprising a sensor-locatable element may allow a better, and/or more gradual position detection of the piston body. The sensor-locatable element may be used in conjunction with other indicators. For instance, the fluid pressure in a chamber may be used to indicate piston position near the end of a chamber. However, the provision of a separate (or additional) sensor-locatable element allows the piston body to be located with higher confidence in the absence of pressure changes that are usually only expected when the piston is close to, or at, an end of a chamber.

In some embodiments, the piston assembly is comprised in a fluid separation system, wherein the piston assembly is part of charging module for pressurising fluid for a separation process.

The disclosure includes a fluid separation system such as a membrane separation system comprising a separation module and a charging module for pressurising fluid for a separation process, wherein the charging module comprises a piston assembly according to any one of the embodiments of the first aspect or second aspect.

In some embodiments, the fluid separation system is a filtration system, specifically a membrane separation system.

The system may be a desalination system, or other liquid separation system such as a decontamination system for the removal of particles from liquids such as water, and from liquid foods such as milk, and other applications.

In accordance with a further aspect of the invention, there is disclosed a filtration system comprising a separation module and a charging module, the separation module and charging module suppliable via a feed line, the feed line arranged to allow it to supply via a first separation module line a first separation module port of the separation module, to allow it to supply via a first charge line a first charge port of the charging module, and to allow it to supply via a second charge line a second charge port of the charging module, the system further comprising an offtake between the first separation module port and the feed line, the offtake allowing one of the first charge line and the second charge line to be fed via the other of the first charge line and the second charge line, wherein the system comprises a line-closing mechanism operable to close the first separation module line between the offtake and the first separation module port.

By filtration system, a system is meant that uses filtration for the separation of components and/or contaminants from a liquid. A filtration system may be provided in the form of a membrane separation system. Filtration systems such as membrane separation systems may be used to generate a clean fluid such as water by reducing a load of a contaminant or component to be removed, such as salt and/or microparticles. As a simplification, herein, it is considered that a filtration system generates a permeate (cleaned fluid fraction) by separating it from a supply of liquid to be separated, whereby the component to be removed from the permeate remains within a retentate with correspondingly increased concentration. Herein, the fluid for separation may be referenced as “fresh fluid” before it undergoes separation, and as “concentrated fluid” when part of the retentate.

In one example, the fresh fluid may be saline to be separated from a feed fluid to generate clean water, resulting in an amount of higher-concentrated saline retentate. However, the principle disclosed herein is not necessarily limited to desalination and may, likewise, be used for the removal of microparticles such as microplastics, separation of foods, such as whey separation from milk, and other filtration processes.

In other applications, it may be the case that the enriched fraction of the retained component is a preferred product. Herein, the expression “clean” is used for fluid removed as permeate from a supply of fluid to be separated, wherein the degree of cleanliness to be achieved may be dependent on the type of fluid, application, regulatory requirements, and other parameters.

In the desalination example described herein, the separation process uses reverse osmosis (RO) via a selectively permeable membrane, that operates by pressurising saline on one side of a membrane of a membrane module, for production of desalinated water permeate on the other side of the membrane.

The charging module is used to assist the pressurisation. As will be appreciated, the performance and degree of separation achieved within a predefined time window depends on relative component concentrations, pressure levels and flow rates. International Patent Publication WO2020/039158A1 discloses a system and method for batch desalination with high efficiency, by using a pressurising chamber or charging module that can be supplied from two sides, during two phases of a batch desalination process. Herein, the charging module is understood as a chamber for pressurising liquid for supply to the separation module, which may be operated by cycling through a phase of pressurisation and separation and another phase of purging and refilling.

In such a separation system, a supply of fluid to be separated may conveniently be provided via a common feed line to supply via a first separation module line the separation module in which the fluid separation is to take place, and to supply two sides (chambers) of a charging module via a first charge line and a second charge line. As a practical setup, the second charge line is an offtake from the feed line (directly and/or via the charging module), as this allows the second charge line to be provided with fluid to be separated either from a fresh supply, or by using retentate from the separation module. As described in WO2020/039158A1, fluid supplied via the second charge line is pressurised in the charging module to be supplied to the separation module. In this manner, the separation module can be supplied via a first separation module port, i.e., via the separation module connection line that is fed from the feed line, and via a second membrane module port from the charging module.

An appreciation underlying the development of the further aspect was that the operation of such a system leads to a relatively higher concentration of components in the retentate, due to the already-separated fraction of higher-concentration fluid being recirculated, and a correspondingly higher demand for membrane maintenance. In this context, membrane maintenance will be understood as an effort to regenerate membrane performance. It has been found that, in practice, membrane performance is difficult to regenerate to 100%. This means that, in practice, membrane performance decreases over time even with regular maintenance.

The suggestion made by the inventors is to further reduce exposure to high contaminant concentrations by introducing an additional flushing step, designed to be carried out in a portion of the system in which a higher concentration of the contaminant, e.g., saline, would otherwise be expected.

The present disclosure introduces a line-closing mechanism, such as a shutter element, that allows the second charge line to be isolated from the first separation module port of the separation module. This enables a flow path encouraging, or forcing, a supply of (fresh) feed fluid through the second charge line and, subsequently, through the charging module. In this manner, the line-closing mechanism counterintuitively blocks a line that would otherwise allow the separation module to be flushed.

As the feed fluid is usually fresh fluid, e.g. fresh saline, it is expected to be less concentrated than recirculated retentate. In this manner, the proposed line-closing mechanism allows, effectively, flushing the second charge line with fresh fluid, i.e. reducing and practically avoiding exposure to retentate with the retained component concentrations that would otherwise be found in the separation module or other regions of the separation system.

Conveniently, the line-closing mechanism is operated during, or as part of, a purging phase of the system, and where possible prior to a refilling phase of the system. In this manner, a clean (low concentration) flushing can be performed while the downtime effect of an additional flushing operation can be reduced.

In some embodiments, the line-closing mechanism is provided as a component of the first separation module port.

In some embodiments, the line-closing mechanism is positioned in the first separation module line between the offtake and the first separation module port.

In some embodiments, the line-closing mechanism is provided as a component of the offtake.

For instance, the offtake may be a manifold or multi-way connection providing fluid passages to connect the first charge line, the second charge line and/or the first separation module line, wherein at least a passage towards and/or constituting the first separation module line is configured to allow it to be shut upon actuation by a control mechanism (such as a controller module or feedback control system).

In some embodiments, the line-closing mechanism is provided by an isolation valve or other suitable fluid flow control valve.

The valve may be of a type operating in a normally-open state to be closed only in certain modes of operation. In this manner, the first membrane module line is normally open and closable upon actuation of the line-closing mechanism. However, this is not necessarily a requirement of all embodiments.

In some embodiments, the charging module comprises a discharge port, wherein the system is configured to allow fluid circulation via the second charge port through at least a portion of the charging module to the discharge port.

As will be appreciated, a discharge port may be used to provide pressurised fluid from the charging module to the separation module.

In some embodiments, the system comprises a recharge pump in the second charge line to assist circulation of fluid from the feed line to the second charge port.

In some embodiments, the recharge pump is controllable to pump fluid at a predetermined flow rate through the second charge port and the discharge port.

In some embodiments, the system is configured to maintain the second charge line open while the first separation module line is closed.

In some embodiments, the system comprises a main supply pump, wherein the main supply pump is used to effect flow through the first charge line and/or second charge line while the first separation module line is closed.

In this manner, the system may be operated in a flushing mode, or line-purging mode, for the second charge line and/or for the charging module. The recharge pump may be operated to achieve a high flow rate to reduce the length of time of the flushing mode. In a practical embodiment, flow through the second charge line is generated by operation of a main supply pump. In this case, the recharge pump may be operated to reduce its interference with fluid circulation through the second charge line. E.g., the recharge pump may be inactive, e.g., in a pass-through mode. Alternatively, the recharge pump may be otherwise operated to reduce its effect on the flow rate through the second charge line.

In some embodiments, the system comprises a moveable partition to separate the charging module into a first compartment and a second compartment, a volume of the first compartment supplied via the first charge port and a volume of the second compartment supplied via the second charge port, wherein the moveable partition is moveable to alter the volumes of the first compartment and second compartment, respectively, wherein the system is configured with a mode of operation in which the moveable partition is positioned to maintain a reduced volume of the second compartment while the first separation module line is closed.

It will be appreciated that the position of the moveable partition may have to allow a fluid passage between fluid ports connecting to the first compartment and/or second compartment. As such, the reduced volume of the second compartment may be a volume achievable while maintaining a fluid passage between fluid ports of the second compartment. This reduces the volume in which higher concentration saline may collect. As such, a reduced volume of the second compartment is believed to result in a more efficient flushing procedure.

In some embodiments, the moveable partition comprises a bypass passage providing a bypass line between the second charge port and the discharge port.

In some embodiments, the moveable partition is provided by a piston.

The piston may be provided by one of the embodiments of the first or second aspects described above.

In some embodiments, the system is configured with a mode of operation in which the moveable partition is positioned to maintain a minimised volume of the second compartment while the first separation module line is closed.

In some embodiments, the minimised volume is no more than 5%, 3%, 2%, or 1% (v/v) of the total volume of the first and second compartments combined.

In some embodiments, the feed line comprises a passage through the charging module, wherein the first charge line supplies the first charge port of the charging module and a discharge port of the charging module supplies the second charge line.

In some embodiments, the system comprises a sensor arrangement configured to measure a separation value indicative of the concentration of the component to be separated in at least one of the feed line, the separation module line, the first charge line, the second charge line, a charging chamber discharge port, and a discharge outlet, wherein the system is configured to operate the line-closing mechanism depending on the separation value.

The separation value may be a measure of the concentration of the component to be removed, or a suitable surrogate measure, in the permeate and/or the retentate. Conversely, in an outlet for permeate, the separation value may be a measure indicative of the absence or low level of the component to be removed. The separation value may, therefore, be indicative of a decrease or increase of a component concentration below or above, respectively, a threshold value. For instance, a suitable indicator for salinity in a desalination system may be provided by a conductivity sensor. Other suitable indicators may be the flow volume, pressure levels, etc. The sensor or sensors of the sensor arrangement may be located at other suitable positions in the system. For instance, one or more sensors may be located downstream of the feed valve, or downstream of the offtake, in the second charge line, or other suitable locations.

In some embodiments, the system comprises a configuration allowing it to operate the line-closing mechanism to shut the separation module line when the separation value meets a predetermined threshold condition indicative of reduced separation performance.

In some embodiments, the system comprises a configuration allowing it to operate the line-closing mechanism to maintain open the separation module line when the separation value meets a predetermined threshold condition indicative of appropriate separation performance.

For instance, the line-closing mechanism may be operated to flush the charge module with a predetermined amount of fresh supply fluid.

In some embodiments, the system is configured to operate the line-closing mechanism for a predetermined period of time.

As an alternative, or in addition to, a sensor arrangement, the line-closing mechanism may be operated to close the separation module line for a predetermined period of time, and to otherwise maintain open the separation module line. The predetermined period of time may be provided as a user input or user setting. Alternatively or in addition, the predetermined period of time may be determined by an algorithm, lookup table, or otherwise.

In some embodiments, the system comprises a plurality of separation modules operable in parallel, each separation module suppliable by the separation module line comprising a further offtake for each further separation module, wherein the line-closing mechanism is located upstream of the or each further offtake and/or provided integrally with the or each further offtake.

The system may comprise two or more separation modules operable in parallel, whereby it is understood that a system configuration may provide that, from time to time, all, or only one or more of the separation modules, are operated simultaneously.

Any one or more embodiments of the first and second aspects may be used in combination with any one or more embodiments of the further aspect and combinations of such embodiments.

### DESCRIPTION OF THE FIGURES

Exemplary embodiments of the invention will now be described with reference to the Figures, in which:

FIG. 1 is a schematic illustration of a prior art desalination system;

FIG. 2 is a schematic illustration of an embodiment;

FIG. 3 shows a side view of a piston component;

FIG. 4 shows a longitudinal section of the FIG. 3 component;

FIG. 5 shows a radial section of the FIG. 3 component;

FIG. 6 shows a section of a pressure vessel in a first configuration;

FIG. 7 shows a section of a pressure vessel in a second configuration;

FIGS. 8 to 12 are schematic illustrations of an embodiment, each of FIGS. 8 to 12 illustrating a different mode of operation of the embodiment; and

FIGS. 13 and 14 are graphs illustrating the performance of different system configurations.

### DESCRIPTION

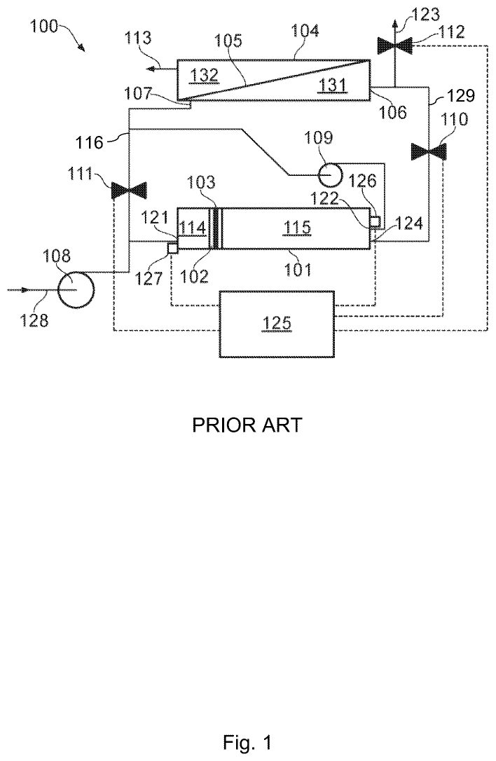

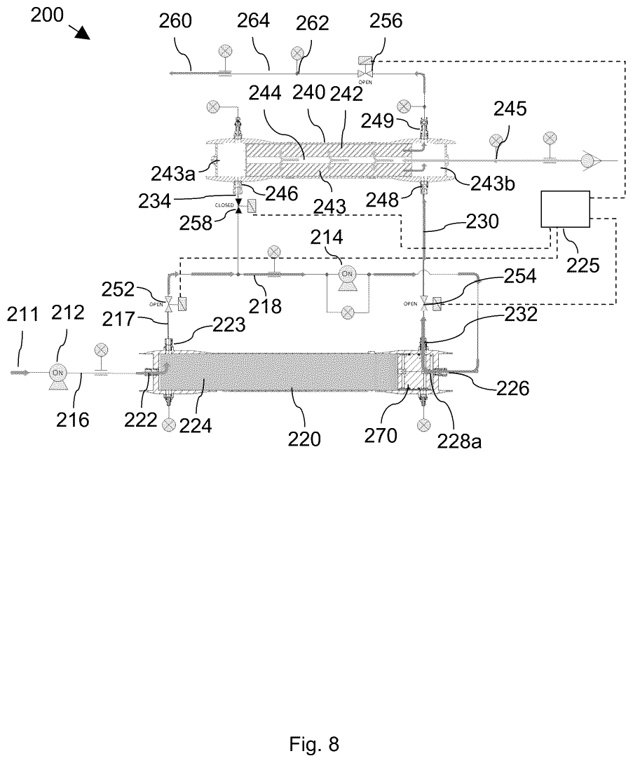

FIG. 1 shows a desalination system 100 of the type disclosed in International Patent Publication WO2020039158A1, the system 100 constituting, here, a filtration system comprising a charging module 101 and a membrane module 104 for reverse osmosis, constituting a separation module. The charging module 101 comprises two chambers 114, 115 in the form a first chamber 114 and a second chamber 115 that are fluidly isolated by a moveable partition 102 such as a piston 103. Movement of the moveable partition 102 causes a corresponding change of volume of the two chambers 114, 115. The first chamber 114 comprises a first charge port 121 via which it may be supplied with liquid fluid to be desalinated, such as saline water. The second chamber 115 comprises a second charge port 126 via which it may be supplied with fluid to be desalinated, and a discharge port 124 for discharging fluid. In this example, the first charge port 121 may be used for both filling and discharging the first chamber 114, however other designs may be used (see, e.g., FIGS. 8 to 12 showing different ports for filling and discharging).

The membrane module 104 comprises a barrier 105 that is selectively permeable, here a reverse osmosis membrane in the form of a spiral-wound structure separating a concentrated side 131 and a clean side 132 of the separation module 104, whereas herein the expression “concentrated” refers to liquid to be separated and retentate, and the expression “clean” refers to permeate or liquid that has a lower concentration of the component (here: saline) to be removed, after passing through the barrier 105 through pressure exerted on fluid in the concentrated side 131 (by coordinating operation of a first pump 108 constituting a main supply pump, the moveable partition 102, and a second pump 109 constituting a recharge pump). Although illustrated as a linear element, the barrier 105 is in this design a spiral-wound or cylindrical structure separating two volumes, e.g., an outer volume from an inner volume. The concentrated side may be an inner side or an outer side. A characteristic of the system 100 is that the concentrated side 131 may be supplied with a supply of liquid or retentate from several (here: two) directions, via either a first membrane module port 107 or a second membrane module port 106. By alternatingly using one of the first and second membrane module ports 106 or 107 for liquid supply, the liquid supply can be used to clean or “flush” built-up concentrations from the membrane 105 that may otherwise experience fouling from a monodirectional gradient of concentrated components. As will be appreciated, the ports 106, 107 may be positioned to supply the retentate side from different sides, e.g., on opposite sides of the retentate side of the membrane, arranged for counterflow, or provided in another suitable arrangement that will be understood to depend at least to some extent on the type of separation structure, such as barrier/membrane module geometry and size. The clean side 132 comprises an outlet 113 for discharging clean fluid.

Fresh liquid to be separated is provided into the system 100 via a feed line 128 with connecting lines to the first charge port 121, the first membrane module port 107 and the second charge port 122. The system 100 is arranged such that fresh liquid may be supplied via the first feed line 128 through the first pump 108, then via a junction or offtake 116 to supply the charging module 101. From the offtake line (comprising the second pump 109), fresh liquid is supplied to the second chamber 115 via the second change port 122 of the charging module 101, from where the second membrane module port 106 is supplied from the discharge port 124. Conveniently, the second charge port 122 may be supplied via the offtake 116 from the feed line 128, the offtake 116 being located between the feed line 128 and the membrane module 104, specifically between first charge port 121 and the first membrane module port 106. Between the offtake 116 and the first charge port, the system 100 comprises a first valve 111 controllable to selectively supply either the first charge port 121 or the offtake 116 to feed the first membrane module port 107 and the second charge port 122. A recharge pump 109 generates and/or assists flow from the offtake 116 towards to second charge port 126. The discharge port 124 of the charging module 101 is connected via a second line 129 to the second membrane module port 106. The second line 129 comprises a second valve 110 and a discharge outlet 123 from the second line 129 that is controllable by a third valve 123. The second valve 110 is positioned to be operable to control flow from the discharge port 124 towards the second membrane module port 106 and the discharge outlet 123, and the third valve 123 is positioned to be operable to control flow from the second line 129 to the discharge outlet 123.

As will be appreciated, appropriate opening and closing of the first valve 111, second valve 110 and third valve 112 allows fluid to pass the membrane module 104 from the first membrane module port 107 through to the second membrane module port 106 (to then exit the system via the discharge outlet 123), or in a reverse direction from the second membrane module port 106 through to the first membrane module port 107, in which case retentate may be routed via the offtake 116 to re-enter the second charge line, and to thereby remain in circulation. With reference to International Patent Publication WO2020039158A1, the system 100 may be operated to carry out three stages (pressurising for separation, purging, and refilling) of a batch desalination process in two phases. In one (first) phase, starting when the second chamber 115 is expanded and filled with saline, the first and third valves 111, 112 are closed and the second valve 110 is open, whereby the saline is contained in a closed circuit such that supplying the first chamber 114 via the first charge port 121 urges the moveable partition 102 to pressurise saline in the second chamber 115 for supply to the membrane 105. In another (second) phase, starting when the second chamber 115 is reduced in size, the first and third valves 111, 112 are open and the second valve 110 is closed, saline is supplied to fill the second chamber 115 via the offtake 116, assisted by the second pump 109, and to feed the first membrane module port 107 to thereby flush the membrane 105, and to allow concentrated retained fluid to be discharged via the second membrane module port 106 through the discharge port outlet 123. The first phase allows pressurising fluid for the separation module (here: for reverse osmosis membrane separation) and the separation of permeate from retentate, while the second phase allows refilling the charge chambers while also purging (or flushing) the separation module. As such, the arrangement allows the membrane module to be supplied in one mode with fluid from one side for purging (flushing) and in another mode with fluid in a pressurised condition from another side for the membrane separation process.

The system described in International Patent Publication WO2020039158A1 reduces the downtimes otherwise required for maintenance and flushing of the membrane 105, because it provides a membrane-flushing arrangement that allows the membrane 105 to be flushed effectively at the same time as the second chamber 115 of the charging module 101 is being refilled.

The membrane-flushing arrangement is effective to allow a desalination system such as system 100 to be operated for prolonged periods of time, which has led to an observation made by the inventors that some parts of a separation system so operated may by design retain more concentrated liquid for longer periods of time. The higher concentration has been found to lead to consequential effects such as a higher pressurisation energy demand, flushing (waste) volume and/or fouling.

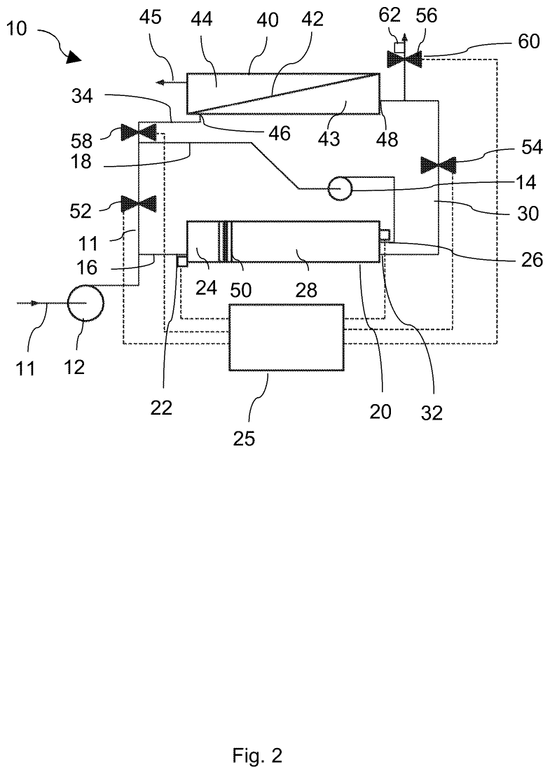

FIG. 2 shows a desalination system 10 that is a modification of the system 100, comprising a charging module 20 and a membrane module 40 constituting a separation module. The charging module 20 comprises a first charge port 22 for charging and draining a first charge chamber 24, a second charge port 26 for charging a second charge chamber 28, and a discharge port 32 for discharging the second charge chamber 24. The membrane module 40 comprises a desalination membrane 42 arranged to separate the membrane module 40 into a retentate (saline) section 43 and a permeate section 44. The retentate section 43 comprises a first membrane module port 46 and a second membrane module port 48, the first and second membrane module ports 46,48 allowing the retentate side of the membrane 42 to be supplied from different flow directions, depending on different modes of operation (described below). The permeate section 44 comprises an outlet 45 for discharging cleaned (e.g., desalinated) fluid.

The first charge chamber 24 and the second charge chamber 28 are fluidly isolated by a moveable partition 50. A first supply line 11 comprises a first pump 12, constituting a main supply pump, a second pump 14, constituting a recharge pump, a first offtake line 16, constituting a first charge line, for supplying the first charge port 22, a second offtake line 18, constituting a second charge line, for supplying the second charge port 26, wherein the second pump 14 is positioned to effect and/or assist flow in the second offtake line 18 towards the second charge port 26, and a third offtake line 34, constituting a separation module line, for supplying the first membrane module port 46. A second supply line 30 connects the second charge port 26 to the second membrane module port 48.

The desalination system 10 comprises a first valve 52, a second valve 54, a third valve 56 and a fourth valve 58. The first valve 52 is located in the first supply line 11 between the first offtake line 16 and the second offtake line 18. The second valve 54 is located in the second supply line 30 between the discharge port 32 and the second membrane module port 48, upstream of a discharge outlet 60 of the second supply line 30. The third valve 56 is located in a position allowing it to control the discharge outlet 60. The fourth valve 58 constitutes a line-closing mechanism and is located in the third offtake line 34 in a position between the offtake feeding the second offtake line 18 and the first membrane module port 46. The system 10 may comprise additional valves, such as a valve in the first offtake line 16 upstream of the first charge port 22, which are not described in detail in the present disclosure.

In practice, it will be appreciated that the fourth valve 58 may be part of the offtake such as a manifold feeding the second offtake line 18 from the first supply line 11, or may part of the first membrane module port 46, or may be located partway along a portion of the third offtake line 34, i.e., in the separation module line.

As will be appreciated, the system 10 may be operated under the instructions of a controller arrangement 25 configured to actuate the first valve 52, the second valve 54, the third valve 56 and the fourth valve 58, which may also control operation of the pumps and other components.

The system 10 may be operated in several modes. In a first mode, the first, third and fourth valves 52, 56, 58 are open and the second valve 54 is closed. This allows the system 10 to operate the purging and refilling mode of the system 100 of FIG. 1. Fresh liquid is supplied via the first supply line 11 and via the second offtake line 18 to charge the second charge chamber 28, and at the same time, fresh liquid is supplied via the third offtake line 34 portion to the first membrane module port 46 for flushing the membrane 42. Excess supply liquid is discharged via the discharge outlet 60 through the third valve 56.

In a second mode, the first and third valves 52, 56 are closed and the second and fourth valves 54, 58 are open. This allows the system 10 to operate the pressurising and separation mode of the system 100 of FIG. 1. Fluid is circulated in a quasi-closed circuit extending through the second charge chamber 28, along the second supply line 30, through the retentate section 43, along the third offtake line 46 and the second offtake line 18, to re-enter the second charge chamber 28 via the second charge port 26.

The pressurisation may be achieved or assisted by supplying further fluid from the first supply line 11 via the first pump 12 to charge the first charge chamber 24, which results in moving the moveable partition 50 to reduce the volume of the second charge chamber 28 (in FIG. 2, by moving it to the right), causing a pressurisation of the fluid and corresponding permeation of cleaned fluid through the desalination membrane 42.

The provision of the fourth valve 58, constituting a line-closing mechanism, such as a shutter or suitable valve mechanism, allows the system 10 to be operated in a third mode, herein also referred to as a line-purging mode. In the line-purging mode, the first, second and third valves 52, 54, 56 are open and the fourth valve 58 is closed, thereby closing the third offtake line that constitutes a separation module line. When the third mode starts, the moveable partition 50 has moved to a position reducing, and practically minimising, the volume of the second charge chamber 28 (i.e., the moveable partition 50 is moved as far as possible to the right side in FIG. 2). In this manner, the first charge chamber 24 has an increased (practically maximised) volume, such that fresh fluid supplied via the first supply line 11 flows via the second offtake line 18 through the second charge port 26. As the third valve 56 is open, fluid flows via the second supply line 30 through the discharge outlet 60.

The fourth valve 58 may remain closed to flush the second charge line 18 and second supply line 30 until a predetermined end point is reached, e.g., for a predetermined period of time, and/or with a predetermined volume of fluid, and/or until a concentration value measured by a sensor arrangement indicates sufficient flushing. The flushing may be effected by flow generated by the first pump 12 only, while the second pump 14 remains inactive. For instance, the second pump 14 may be, depending on the type of pump, in a bypass mode or may be operated as much as is necessary to permit flow and/or to avoid interfering with flow generated by the first pump 12.

After sufficient flushing of the supply and offtake lines, the system may be operated to resume the first mode. To this end, the first and third valves 52, 56 remain open, the second valve 54 is closed and the fourth valve 58 is opened. The process may be repeated several times, and for practical purposes as long as desired or as long as allowed by maintenance requirements, by looping through the three afore-described modes (purging and refilling mode, pressurising and separation mode, and line-purging mode). Carried out in this sequence, the line-purging mode can be carried out once, or while, the moveable partition 50 is in a position in which the second charge chamber 28 has a small volume.

The discharge outlet 60 comprises a saline concentration sensor, constituting a sensor to measure a separation value indicative of the concentration of a component to be separated, such as a conductivity sensor 62 that is configured to measure the saline concentration of the discharged saline. This allows the separation performance to be monitored. Other sensor types may be used, and sensors may be located at other appropriate locations. The provision of a sensor arrangement to monitor the separation performance allows the system 10 and the transition from one mode to the next mode to be operated in the form of a closed-loop control. A measurement value obtained via the concentration sensor may be used as an input value for determining whether or not the system 10 should continue to be operated in the line-purging mode or proceed to the first mode (purging and refilling mode). A change of mode may be effected depending on the conductivity or saline concentration value indicating a low (i.e., sufficiently washed) saline concentration. As will be appreciated, depending on the system design, the type of fluid to be separated, and/or the type of component to be separated from the fluid, different concentration indicators may be used. The threshold for determining the concentration may be an absolute threshold value or range, a relative threshold, or a rate of change. Alternatively, or in addition, to modulating the operation of the system based on separation values, the modes may be switched depending on timing, flow volumes, flow rates, and/or take into account multiple parameters. In some system configurations, the switching between modes may be based on pre-determined time intervals.

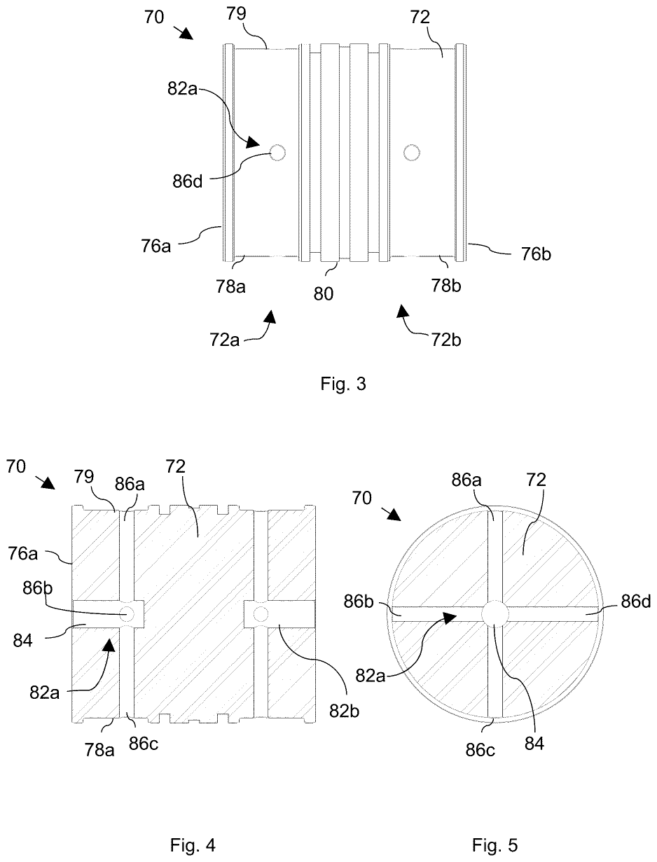

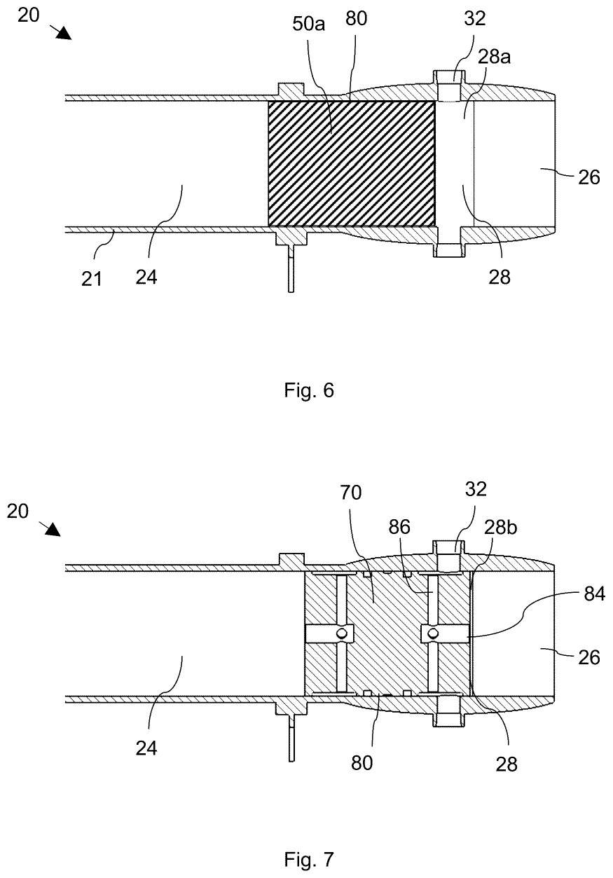

Referring to FIGS. 3 to 5, a piston design of a piston 70 is shown that may be used as a moveable partition in the system designs described herein. The piston 70 comprises a generally cylindrical piston body 72 with a first piston end 72a opposite a second piston end 72b. Each piston end 72a, 72b comprises a generally round end face 76a, 76b and a mantle portion 78a, 78b, respectively. The two piston ends 72a, 72b are separated by a groove arrangement 80 located partway (here: midway) on the piston body 72 between the two piston ends 72a, 72b. The groove arrangement 80 provides seating surfaces for additional components to be located on the piston body 72. This allows the piston body 72 to be provided with a seal structure, and/or with a position indicator such as a magnetic band, or combinations thereof. The groove arrangement 80 may be constituted by, and/or comprise, precision machined seal surfaces and/or may be constituted by an arrangement of grooves for retaining a sealing element such as a dynamic seal element, for instance an O-ring or other appropriate seal component (not shown). Each piston end 72a, 72b is provided with a multi-arm piston conduit 82a, 82b, each piston conduit 82a, 82b comprising multiple arms providing a fluid passage between different surface locations of the piston body 72. In the present embodiment, the piston conduits 82a, 82b are arranged symmetrically to each other, and so only one piston conduit 82a (here: on the left-hand side of FIG. 4) is described herein. The piston conduit 82a constitutes a piston passage and comprises a first, axial passage arm 84 open to the end face 72a (here: open at the centre of the end face 72a). The axial passage arm 84 extends partway into the piston body 72 to a junction where, from the axial passage arm 84, a plurality of (here: four) radially extending arms 86a,b,c,d extend equiangularly spaced apart in a cruciform manner (see FIG. 5) and open to different locations around the mantle portion 78a, each radially extending arm 86a,b,c,d providing a mantle opening. As shown in FIG. 4, the mantle openings extend into a groove 79 extending circumferentially around the mantle, which facilitates fluid ingress and egress via the radially extending arms 86a,b,c,d through the mantle opening in tight piston housings. Furthermore, the provision of a groove allows a smaller number of (here: four) radial extending arms 86a,b,c,d to be provided while still enabling fluid communication with corresponding ports regardless of the rotation of the piston body 72. As such, the groove 79 avoids the need to ensure rotational alignment of the piston body 72 inside its housing.

As will be appreciated from FIG. 4, the multi-arm piston conduit 82a provides a fluid passage internally within the piston body from the mantle portion 78a through the radially extending arms 86a,b,c,d and the axial passage 84 to the end face 76a. The description of the second multi-arm piston conduit 82b is not repeated, because it is, in this example, symmetric to the first multi-arm piston conduit 82a. As such, the piston conduits 82a, 82b each provide a bypass flow path (here: a multi-arm conduit) from several (here: four) locations around the mantle portion 78a to the end face 76a at the piston end 72a.

The two piston conduits 82a and 82b are fluidly isolated from another. While the piston illustrated herein is of generally round cross-section (see FIG. 5), the geometry of the piston may be different, to correspond to a piston housing in which the piston is disposed.

The piston body may be provided as a single-piece element, or in the form of an assembly comprised of two or more piston body elements. A multi-piece piston may facilitate the manufacture and/or maintenance of complex piston body shapes. Furthermore, the flow passages in the piston body may have any size and diameter. For instance, the piston body may have a ring-shaped, hollow form, for instance if an axial passage such as the axial passage 84 makes up a large proportion of the diameter of the piston body.

FIG. 6 illustrates a side view section of a piston 50a in a charging chamber 20. FIG. 7 illustrates a side view section of an arrangement comprising the above-described piston 70 in the charging chamber 20. The arrangements of FIGS. 6 and 7 show the same charging chamber, and so the same numerals are being used for the description of the same components thereof. However, the piston in FIG. 6 is a generic piston 50a serving as a moveable partition, whereas the piston assembly of FIG. 7 uses the piston 70 of FIGS. 3 to 5 that comprises a multi-arm piston conduit 82.

In both FIGS. 6 and 7, the charging chamber 20 comprises a chamber wall 21 that constitutes a piston housing. In this embodiment, the charging chamber 20 comprises a generally cylindrical cavity in which the piston (piston 50a in FIG. 6, piston 70 in FIG. 7) is axially moveably disposed. Each piston 50a, 70, respectively, comprises a seal arrangement 80 that fluidly separates the charging chamber in a first charge chamber 24, constituting a first chamber end, and a second charge chamber 28, constituting a second chamber end. As will be appreciated, the volume (size) of the first and second charge chambers 24, 28 can be changed by positioning the piston 50a or 70 along the charging chamber 20, which may be affected by feeding liquid e.g., into the first charging chamber (see description of FIG. 2 above). The charging chamber 20 comprises, at the side of the second charge chamber 28, a discharge port 32 and a second charge port 26 (indicated only schematically in FIGS. 6 and 7). The second charge port 26 may be used, in the manner described above, to supply liquid into the second charge chamber.

The piston 50a in FIG. 6 comprises, for the purpose of this description, no internal bypass passage. As such, if it is desired to allow fluid to pass from the second charge port 26 through to discharge port 32, a minimum volume 28a must be kept free to maintain a flow path from the second charge port 26 to the discharge port 32. The minimum volume 28a is kept free by preventing the full movement or sweep of the piston 50a towards the end of the charging chamber 20. The volume may be maintained by use of abutment edges (not shown) that limit piston movement, or other suitable limiter mechanisms, such as by controlling the amount of liquid fed into the first charge chamber 24.

Referring to FIG. 7, the piston 70 comprises a multi-arm bypass passage (corresponding to one of the passages 82a, 82b shown in FIGS. 3-5) in the form of an axial passage 84 and radial arms 86 that provide an internal flow path to connect the second charge port 26 and the discharge port 32 when the piston 70 is moved closer towards the end of the charging chamber 20. In this manner, the second charge chamber 28 has a free volume 28b that is much smaller than the volume 28a indicated in FIG. 6. To provide an illustrative value, the free volume 28b and fluid passage volume of the multi-arm fluid passage 82 (passage 84 and arms 86a,b,c,d) may be less than 50%, 40%, 30%, 20%, or less than 10% of the volume 28a that is achievable when a piston without bypass passage is used. As will be appreciated, the volume reduction depends on the location of the fluid ports, dimension of housing and piston travel. The volume reduction practically achievable may also depend on the type of liquid and its flow properties, such as its viscosity.

The arrangement of FIG. 7, using a piston design as described in FIGS. 3 to 5, is of benefit during a line-purging mode as described with reference to FIG. 2, because it provides a relatively small volume 28b of the second charge chamber 28 in which concentrated, or enriched, retentate may be retained during the flushing operation of a line-purging procedure. The volume reduction thus achieved can have considerable benefit, because the fluid otherwise retained in the free volume of the charge chamber may have gone through several recirculation cycles resulting in a considerably higher concentration than in the fresh feed liquid. As a consequence, ensuring a smaller free volume of the charging chamber allows a line-purging procedure (according to the third mode of operation described above) to be shorter than would otherwise be the case.

Furthermore, the piston design comprising bypass passages has been found to facilitate the draining of the system to remove fluid when this is required, for instance, prior to maintenance or disassembly for transportation. As will be appreciated, as the bypass passages help to prevent a blockage of ports, the piston design disclosed herein allows the piston to remain in any position along the charging module without this affecting a draining procedure. As will be appreciated, the piston may be of a hollow design, for instance with a larger-diameter passages or a larger number of passages. Such “hollower” piston designs may be used, for instance, in applications in which volume reduction is of lesser interest than a bypass aspect and/or drainage aspect.

The piston design of FIGS. 3 to 5 may also be used to provide a bypass fluid supply through the first chamber of the charging module, as illustrated in FIGS. 8, 10 and 12.

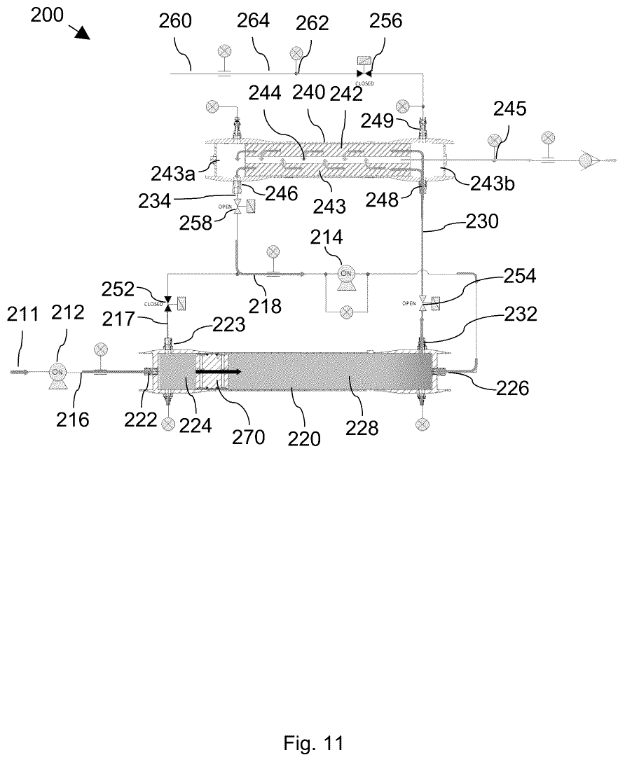

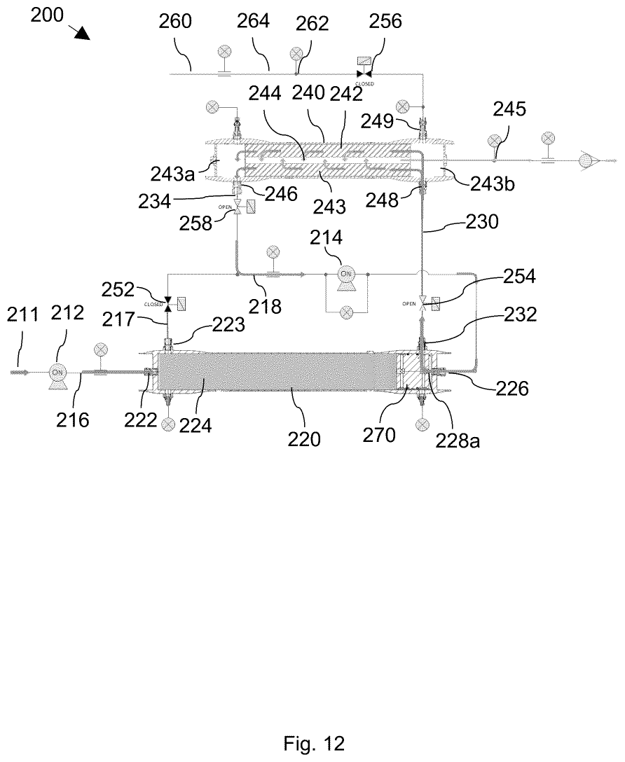

FIGS. 8 to 12 show another desalination system 200 constituting another separation system design, whereas each of FIGS. 8 to 12 show the same embodiment in a different phase of operation. As such, the same numerals are repeated for the same components of the system 200, without repeating a detailed description for each figure. The desalination system 200 constitutes an embodiment in which different aspects of this disclosure are combined. The phases of operation may be defined by the operation (closing and/or opening, respectively) of the valve arrangement of the system. If defined in this manner, FIGS. 11 and 12 will be understood to illustrate different points in time of one phase.

The desalination system 200 comprises a charging module 220 and a membrane module 240 constituting a separation module. The charging module 220 comprises a first charge chamber 224 and a second charge chamber 228, a first charge port 222 to supply the first charge chamber 224 a first discharge port 223 for discharging the first charge chamber 224, a second charge port 226 to supply the second charge chamber 228 and a second discharge port 232 fluidly connecting the second charge chamber 228 via a pressured supply line 230 to the membrane module 240.

The first charge chamber 224 and the second charge chamber 228 are fluidly isolated by a moveable partition 270. A first supply line 211, constituting a feed line, comprises a first pump 212, constituting a main supply pump, and a first supply line section 216, here providing a first charge line constituted by a portion of the feed line to supply the first charge port 222. In the desalination system 200, a supply of fresh liquid leads through the first charge port 222 via the first discharge port 223 into a second supply line section 217. The second supply line section 217 connects to a connection line 234, constituting a separation module line, connecting the membrane module 240 via a first membrane module port 246 with the second supply line section 217. Further, the second supply line section 217 leads to an offtake line 218 constituting a third supply line section, or recirculation line, constituting a second charge line, towards the second charge port 226. A second pump 214, constituting a recharge pump, is located in the offtake line 218.

The membrane module 240 comprises a desalination membrane 242, here of spiral-wound form, separating the membrane module 240 into a retentate section 243 of (generally) annular volume and a permeate section 244. In this embodiment, the permeate section 244 is a generally cylindrical volume inside the retentate section 243. Due to the manner in which the membrane 242 is located in the membrane module 240, the retentate section 243 comprises chambers 243a and 243b providing free volumes at the ends (here: left and right) of the coiled membrane 242, the chambers 243a, 243b suppliable via a first membrane module port 246, connecting to one chamber 243a, and a second membrane module port 248, connecting to another chamber 243b. In this manner, the retentate section 243 of the membrane 242 may be supplied with fluid from different directions, either via the first membrane module port 246 (here: from the “left-hand” side, for purging), or via the second membrane module port 248 (here: from the “right-hand” side, in pressurised condition, for membrane separation). The permeate section 244 comprises an outlet 245 for discharging the permeate, such as cleaned fluid (e.g., desalinated water). Although omitted for simplicity of the illustration, it will be appreciated that the configuration includes a fluid conduit (not shown) extending from the permeate section 244 through, and fluidly isolated from, the chamber 243b and through the housing of the membrane module 240. As such, the fluid passage from the permeate section 244 to the outlet 245 is fluidly isolated from the chamber 243a, 243b. The chamber 243b comprises, in this example, the membrane module discharge port 249 connecting via a discharge line 264 to a discharge outlet 260. A conductivity sensor 262, constituting a sensor arrangement for monitoring separation performance, is located in the discharge line 264.

The desalination system 200 comprises a first valve 252, a second valve 254, a third valve 256 and a fourth valve 258. The first valve 252 is located in the second supply line section 217, between the first discharge port 223 and the offtake line 218. The second valve 254 is located in the pressured supply line 230, between the second discharge port 232 and the second membrane module port 248. The third valve 256 is located in the discharge line 264, positioned downstream of the membrane module discharge port 249 to control flow through the discharge line 264 towards the discharge outlet 260. The fourth valve 258 constitutes a line-closing mechanism and is located in the in the connection line 234 between first membrane module port 246 on one side, and on the other side the offtake line 218 and second section supply line section 217. Herein, the fourth valve 258 is illustrated set apart from the first membrane module port 246, although in some embodiments the fourth valve 258 may be integral with the port 246. As will be appreciated, the fourth valve 258 may be operated to block flow through the connection line 234 between the offtake line 218 and the membrane module 240.

The system 200 may be operated under the instructions of a controller arrangement 225 (illustrated in FIG. 8 only) configured to actuate the first valve 252, the second valve 254, the third valve 256 and the fourth valve 258, and may also be configured to control the operation of the pumps and other components.

The moveable partition 270 is, in this embodiment, constituted by a design corresponding to the piston 70 illustrated in FIGS. 3 to 5, comprising multi-arm fluid conduits providing internal bypass passages through the piston body of the moveable partition 270. The ports 222, 223 are arranged at the first chamber end of the charge chamber 220, and the ports 226, 232 are arranged at the second chamber end of the charge chamber 220.

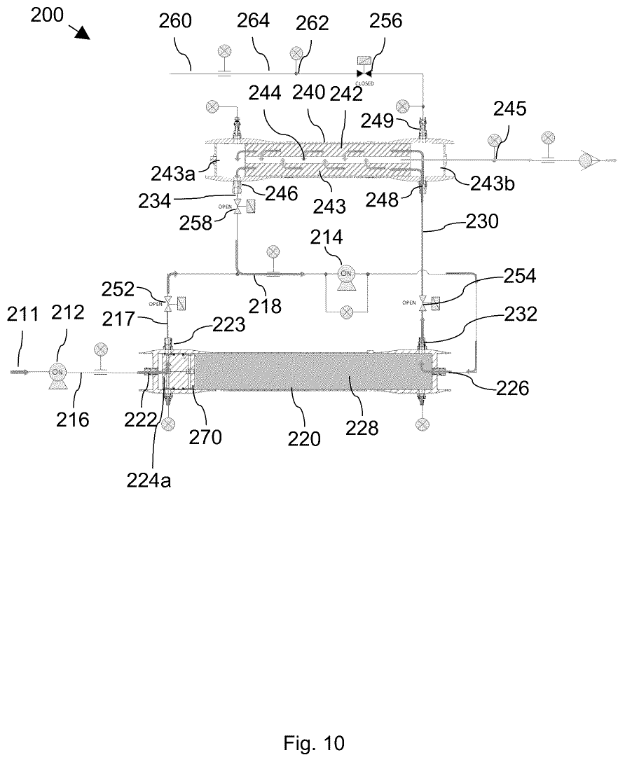

The configuration of the multi-arm fluid conduits of the moveable partition 270 corresponds to the locations of the ports 222, 223 and 226, 232, respectively, such that the openings of the moveable partition 270 align and register with their respective ports. When the moveable partition 270 is in a distal position at the first charge port 222 (see position on the “left” side in FIG. 10), the internal bypass passage provides a fluid conduit from the first charge port 222 through the moveable partition 270 to the first discharge port 223. In this manner, positioning the moveable partition 270 distally (here: at the first charge port 222) does not block the flow path to the first discharge port 223, resulting in a considerably reduced residual volume 224a of the first charge chamber (FIG. 10). Likewise, when the moveable partition 270 is in a distal position at the second charge port 226 (see position in the “right” side of FIG. 12), the internal bypass passage provides a fluid conduit from the second charge port 226 through the moveable partition 270 to the second discharge port 232. Positioning the moveable partition 270 distally (here: at the second charge port 226) does not block the flow path to the second discharge port 232, resulting in a considerably reduced residual volume 228a of the second charge chamber (FIG. 12). In applications in which such volume reduction is not sought, the partition 270 may comprise a correspondingly larger-diameter axial passage, or multiple passages.

FIGS. 10 and 12 illustrate how the residual volumes 224a (FIGS. 10), 228a (FIG. 12) of the first and second charge chambers 224, 228 can in this manner be minimised. By reducing the residual volumes 224a, 228a, the likelihood is increased that flushing procedures remove higher-concentration retentate more effectively, because dead volumes are reduced.

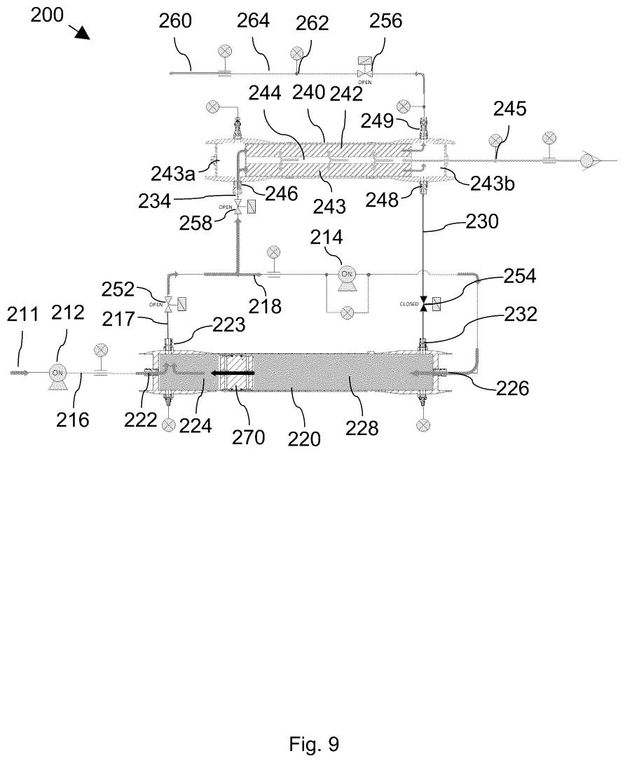

In the desalination system 200, the use of the piston 70 as a moveable partition 270 is combined with the operation including a fourth valve 258. To this end, the desalination system 200 may be operated by cycling through four modes, including an additional “hybrid” mode compared to the description of FIG. 2. The modes are a line-purging mode (FIG. 8), a purging and refilling mode (FIG. 9), an additional hybrid mode (FIG. 10), and a pressurising and separation mode (FIGS. 11 and 12).

Describing first a line-purging mode or phase, illustrated in FIG. 8, the first valve 252, second valve 254, and third valve 256 are open, and the fourth valve 258 is closed. The line-purging mode may be the first phase of operation prior to an initial filling of the system. Once in operation, the line-purging mode may follow after the pressurising and separation mode (FIGS. 11 and 12 below) and, as such, the offtake line 218 is expected to be filled with retained liquid having a relatively high concentration of the component to be removed. The moveable partition 270 is at, or has reached, the end of the second chamber 228, which has reduced to a minimum volume 228a. Fresh liquid is supplied via the first supply line section 216 via the first pump 212 through the first charge port 222 into the first charge chamber 224, through the first discharge port 223, bypassing the open first valve 252 through the second supply line section 217. At the offtake, flow towards the first membrane module 246 is blocked by the closed fourth valve 258, and supply passes only through the offtake line 218, “flushing” the offtake line 218 with fresh liquid. The flow rate through the offtake line 218 may be controlled by the first pump 212. The flow rate may be controlled by the first pump 212 only. In that case, the second pump 214 may be controlled not to affect the flow rate, for instance by setting the second pump 214 to a bypass mode and/or by ensuring the operation of the second pump 214 maintains a desired flow rate through the offtake line 218. The fresh liquid is expected to have a lower concentration of a component to be removed than concentrated retained liquid from the previous separation phase. The fresh liquid thereby helps to flush retained liquid towards the second charge port 226, where it bypasses the moveable partition 270. Liquid flow is permitted through the open third valve 256 via the second discharge port 232 towards the second membrane module port 248, the chamber 243b and the membrane module discharge port 249 towards the discharge outlet 260. Effectively, fluid may pass directly from the second membrane module port 248 via the chamber 243b through the membrane module discharge port 249. As will be appreciated, the closing of the fourth valve 258 allows, in this manner, fresh liquid to be used to flush (or purge) the offtake line 218. Retentate in the offtake line 218 can thereby be removed via the discharge port 249.

Turning to FIG. 9, a refilling and purging mode is described that is akin to the first mode described in relation to FIG. 2 above. The fourth valve 258 is opened and the second valve 254 closed, while the first valve 252 and the third valve 256 remain open. With liquid supply continuing via the first charge chamber 224, the closure of the second valve 254 forces the filling of the second charge chamber with liquid supplied via the second charge port 226, by causing this to push the moveable partition 270 towards the first charge port 222 (here: towards the left) and increasing the volume and amount of liquid held in the second charge chamber 228. To this end, the second pump 214 may operate faster than the first pump 212, although this may not be the case in all system configurations. As will be appreciated, by appropriate control of the pump performance of the second pump 214 and the first pump 212 relative to each other, a slower or faster filling of the second charge chamber 228 can be achieved. When the second charge chamber 228 is extended and filled, the moveable partition 270 is understood to have travelled towards the distal end near the first charge port 222 (to the left), and the flow rate through the second pump 214 stops. With the fourth valve 258 open, part of the fluid supply bypasses the offtake line 218 and flows through the separation module connection line 234 through the first membrane module port 246, entering via the chamber 243a the membrane module 240. In this way, the purging aspect of this mode is provided in that fresh fluid is used to flush the membrane side of the retentate section 243 before leaving the membrane module 240 via the membrane module discharge port 249. The conductivity meter 262 may be used to monitor the conductivity as surrogate measure for saline concentration. In this manner, changes in the conductivity value may be used to monitor performance and/or control operation of the system and/or of each phase individually. As will be appreciated, other sensor solutions may be used.

Turning to FIG. 10, this illustrates an additional mode or phase of the system that may be carried out between the first mode and the second mode described in FIG. 2 above. In the additional mode, once the second charge chamber 228 has been filled, the system is controlled to maintain the moveable partition 270 at the left-hand side of the charge chamber 220. By using a movable partition as illustrated in FIGS. 3 to 5, a reduced-volume flow passage is provided to connect the first charge port 222 to the first discharge port 223. The third valve 256 is closed and the second valve 254 opened, while the first valve 252 and the fourth valve 258 remain open. In the additional mode, fluid is re-circulated through the pressured supply line 230 to enter the membrane module 240 via the second membrane module port 248 and pass across the membrane 242 in pressurised condition, thereby resulting in permeate to pass the membrane 242 towards the permeate fluid section 244 end exiting via the outlet 245. Fluid that remains on the retentate section 243 exits the membrane module via the chamber 243a and the first membrane module port 246, passing through the connection line 234 and re-joining the offtake line 218. In the additional mode, pressure levels are increasing linearly by providing a supply of fresh liquid from the supply line 211 to replenish fluid volume in the retentate side corresponding to the amount of permeate removed via the membrane 242.

The additional mode of FIG. 10 is followed by a pressuring and separation mode, illustrated in FIGS. 11 and 12, that is akin to the second mode described in relation to FIG. 2 above. The first valve 252 is closed. The third valve 256 remains closed and the second valve 254 and the fourth valve 258 remain open. In the pressuring phase, supply of fresh liquid fills the first charge chamber 224, forcing the moveable partition 270 towards the chamber end comprising the second charge port 226. This pressurises liquid contained within the second charge chamber 228, forcing recirculation through the pressured supply line 230, through the retentate section 243, and via the separation module connection line 234 to join the offtake line 218. During this phase, permeation through the membrane 242 continues to increase the output of permeate through the outlet 245.

Turning to FIG. 12, this shows the end of the pressuring and separation mode, when the moveable partition 270 has reached the end of the charge chamber 220 containing the second charge port 226 (here: to the right-hand side). Due to the internal bypass passage (see multi-arm conduit 82a or 82b in FIGS. 3 to 5), a flow path remains from the second charge port 226 to the second discharge port 232. As such, the moveable partition 270 can be allowed to be moved further towards the end of the charge chamber 220, resulting in a smaller dead volume for high-concentration fluid to remain.

The process continues by switching from the end of the pressurising and separation mode of FIG. 12 to the line-purging mode configuration illustrated in FIG. 8. The desalination system 200 is believed to reduce the likelihood of scaling and/or fouling, and to reduce the average pressure levels during operation, because the fourth valve 258 enables a phase of operation (herein referred to as line-purging mode), as illustrated in FIG. 8, in which the offtake line 218 can be flushed with fresh liquid. In addition, a configuration using a piston with bypass passages allows dead volumes at the distal ends of the charge chamber 220 to be reduced, as illustrated in FIGS. 10 and 12, compared to configurations using a conventional piston design. The combination of both aspects results in an even further improved effect.

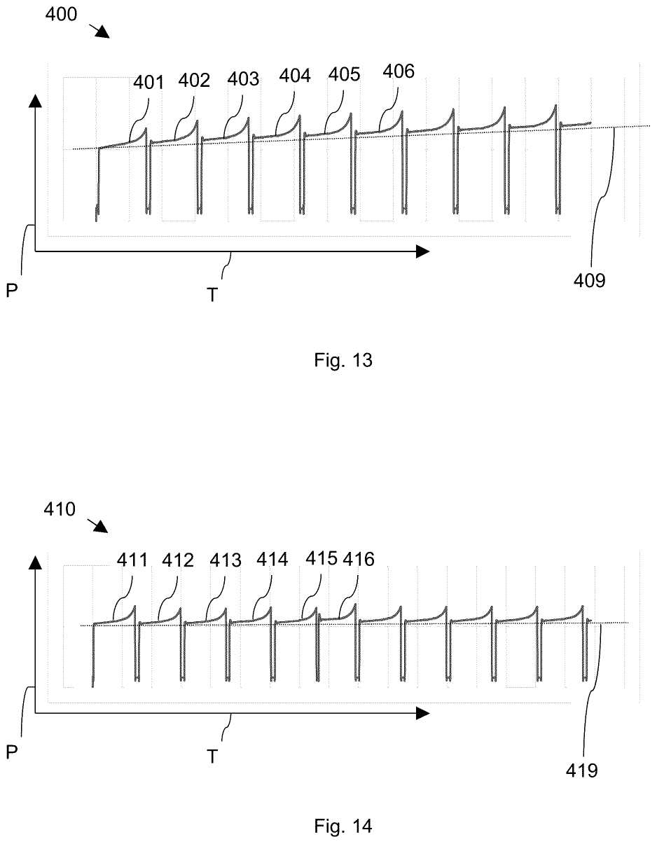

Referring now to FIGS. 13 and 14, these illustrate pressure P (corresponding to the energy requirements for circulation) over time T (corresponding to system operation cycles) during an initial phase of operation. FIG. 13 shows a graph 400 for a system without a flush valve, corresponding to a configuration of FIG. 1, showing the pressure levels measurable during a several cycles 401, 402, 403, 404, 405, 406 etc. As will be appreciated, each cycle has a characteristic increase during the pressurising phase, followed by a drop and repeat in the next cycle. With increasing concentration of a retained component, such as saline, it is possible to observe a trend baseline 409 that indicates increasing pressurisation energy demand. After some operation cycles, the trend baseline 409 will no longer increase and eventually reach a plateau (not indicated in FIG. 13), however the level of the plateau will be expected to be higher than the trend baseline 409 during the first cycles.

Turning to FIG. 14, this shows a graph 410 for a system including a flush valve of the invention, allowing the offtake line to be flushed with fresh liquid. The graph 410 shows characteristic pressure cycles 411, 412, 413, 414, 415, 416 etc. However, in contrast to the graph 400 of FIG. 13, the trend baseline 419 is flatter (here: nearly horizontal). The trend baseline 419 may also reach a plateau level, which is expected to be a relatively lower plateau level compared to FIG. 13, indicating that the additional line-purging mode, i.e. the flushing of the charge lines supplying the charging module, helps to reduce the pressurisation demand by using an additional flushing process to reduce the amount of concentrated retentate in circulation.

Herein, the invention has been described using the example of a desalination system using membrane separation to create a desalinated permeate from a supply of saline. It will be appreciated that the principle of the invention may also be applicable in other purification processes and/or downstream processes, such as ultrafiltration, nanofiltration, and microfiltration, specifically when components to be removed may be intentionally enriched, or retained in higher concentration, by recirculation during a batch or semi-batch operation, as may be expected, for instance, during reverse osmosis processes. The principles disclosed herein are believed to be applicable for solutions, suspensions, and combinations thereof, e.g. for processes separating salts from solution, as well as for processes separating suspended solids such as particles, proteins, microplastics etc from liquids such as water and/or liquid foods.

Whilst the principle of the invention has been illustrated using exemplary embodiments, it will be understood that the invention is not so limited, and that the invention may be embodied by other variants defined within the scope of the appended claims.

1. A piston assembly for use in a fluid circulation system, the piston assembly comprising a piston housing defining a chamber comprising a first chamber end and a second chamber end, the piston assembly comprising a piston body comprising a sealing portion to fluidly separate the first chamber end from the second chamber end, the piston body moveably disposed to allow it to change volumes of the first and second chamber ends, respectively, wherein at least the first chamber end comprises a first fluid port and a second fluid port spaced apart from the first fluid port, wherein the piston body comprises a first piston passage open to a first side of the sealing portion, the first piston passage providing a first connecting passage from the first fluid port to the second fluid port when the piston body is located at the first chamber end, and wherein the sealing portion maintains fluid separation to the second chamber end.

2. The piston assembly according to claim 1, wherein one of the first fluid port and the second fluid port is located at an end face of the first chamber.

3. The piston assembly according to claim 2, wherein the other of the first fluid port and the second fluid port is located laterally of the end face of the first chamber.

4. The piston assembly according to claim 1, wherein the second chamber end comprises a third fluid port and a fourth fluid port spaced from the third fluid port, wherein the piston body comprises a second piston passage open to a second side of the sealing portion, the second piston passage providing a second connecting passage from the third fluid port to the fourth fluid port when the piston body is located at the second chamber end, and wherein the sealing portion maintains fluid separation to the first chamber end.

5. The piston assembly according to claim 4, wherein one of the third fluid port and the fourth fluid port is located at an end face of the second chamber.

6. The piston assembly according to claim 5, wherein the other of the third fluid port and the fourth fluid port is located laterally of the end face of the second chamber.

7. A piston body for use in a piston assembly of a fluid circulation system, the piston comprising a body comprising an elongate extension between two opposite ends, the body comprising a body portion partway between the two opposite ends arranged to fluidly isolate the two opposite ends, wherein the opposite ends each comprise an end face and a mantle portion defined by a perimeter of the body, and wherein the body comprises a piston passage extending from an end face to the mantle portion.

8. The piston assembly according to claim 1, comprising at least one piston passage at each one of its opposite ends.

9. The piston assembly according to claim 1, wherein at least one piston passage comprises a plurality of mantle openings on the piston body.

10. The piston assembly according to claim 9, wherein the mantle openings are radially spaced apart on the piston body.

11. The piston assembly according to claim 1, wherein the piston body comprises a groove into which one of the ports of the piston passage extends.

12. The piston assembly according to claim 11, wherein the groove is provided peripherally on a mantle surface of the piston body.

13. The piston assembly according to claim 1, wherein at least one of the ports is located centrally on an end face of the piston body.

14. The piston assembly according to claim 1, wherein at least one of the ports is located off-centre on an end face of the piston body.

15. The piston assembly according to claim 1, wherein the sealing portion comprises a surface of the piston body.

16. The piston assembly according to claim 1, wherein the sealing portion comprises at least one seal element.

17. The piston assembly according to claim 1, wherein the piston body comprises a sensor-locatable element for use with a position sensor.

18. The piston assembly according to claim 1, comprised in fluid separation system, wherein the piston assembly is part of a charging module for pressurising fluid for a separation process.

19. A filtration system comprising a membrane module and a charging module for pressurising fluid for filtration, wherein the charging module comprises at least one piston assembly according to claim 1.

20. The filtration system according to claim 19, wherein the filtration system is a desalination system.
